(19) United States
(12) Patent Application Publication
(10) Pub. No.: US 2007/0137359 A1
(43) Pub. Date: Jun. 21, 2007

(54) Speed changing operation apparatus for vehicle

(76) Inventors: Tetsuji Ohno, Shizuoka-ken (JP); Masayuki Shinmura, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/529,093

(22) Filed: Sep. 28, 2006

(30) Foreign Application Priority Data
Sep. 28, 2005 (JP) 2005-281173

(51) Int. Cl. F16H 59/04; G05G 1/10

(52) U.S. Cl. 74/473.3; 74/543

(57) ABSTRACT

A lever assembly, which can be used as a speed changing apparatus for vehicle, can include an operating lever shaft. The operating lever shaft can be pivotally supported on a speed changing operation unit. An operating knob can be formed with a mounting bore for receiving a top end of the operating lever shaft and can also be adapted to be mounted on the top end of the operating lever shaft for carrying out a speed changing operation of a transmission of vehicle by pivoting the operating lever shaft. An engagement member can have a cylindrical configuration of substantially same inner circumferential configuration as an outer circumferential configuration of the operating lever shaft. The engagement member can be adapted to be received and secured within the mounting bore of the operating knob and can have nails that are elastically deformable by the operating lever shaft and engaged therewith when the operating lever shaft is inserted through the engagement member.

### CROSS-REFERENCE TO RELATED APPLICATIONS

The present application is based on and claims priority under 35 U.S.C. § 119 to Japanese Patent Application No. 2005-281173, filed on Sep. 28, 2005, the entire contents of which is expressly incorporated by reference herein.

### BACKGROUND OF THE INVENTIONS

1. Field of the Inventions

The present inventions relate to a speed changing operation apparatus for vehicle for carrying out the speed changing operation of a transmission.

2. Description of Background Art

Speed changing operation apparatuses for vehicles generally comprise an operating lever shaft and an operating knob mounted on the top end of the operating lever shaft. Such devices allow a user to carry out a speed changing operation of the transmission of vehicle by pivotally operating the lever shaft with gripping the operating knob. These devices are also known as “gear shifters”.

For example, as disclosed in Japanese Patent Domestic Publication No. 513000/2004, an operating knob is formed with a mounting bore (pocket 34) extending upwardly from its bottom surface into which a top end of an operating lever shaft (shaft 14) is adapted to be inserted. The operating knob is prevented from being slipped out from the shaft and from being rotated relative to the shaft by elastic force of a fastener (18) secured in the mounting bore.

The fastener (18) comprises a top (18) being abutted against a projected end of the operating lever shaft, a pair of legs (22, 24) extending downward from the top (18), and an elastic flange (28) formed on one of the legs (24). The top end of the operating lever shaft abuts against the top (18) and the elastic flange (28) engages a notch (40) on the top end of the operating lever shaft when the lever shaft is inserted into the mounting bore of the operating knob. Accordingly it is possible to assemble the operating knob and lever shaft only by inserting the top end of the lever shaft into the mounting bore of the knob and thus it is possible to reduce the assembling steps as compared with an assembling method for example using screws.

### SUMMARY OF THE INVENTIONS

An aspect of at least one of the embodiments disclosed herein includes the realization that a rattle between a knob and a lever in the prior art noted above, can be caused by a problem in the arrangement of the elastic flange formed on one of the pair of legs and the elastic flange engaged with the notch with the top end being abutted against the end of the lever shaft. That is, according to such prior art designs, since only the elastic flange of one of the legs and the other leg are abutted against the circumference of the lever shaft, the rattle tends to be caused because there is no support in directions other than the abutted direction.

Additionally, another problem in the above-noted prior art is that the length of the legs can be extremely extended when the position of elastic support is set at the base of the lever shaft (e.g. when the notch is set at the base side of the lever shaft), since the top forming the fastener is abutted against the end of the lever shaft.

Thus, in accordance with at least one of the embodiments disclosed herein, a speed changing operation apparatus can be provided for a vehicle. The speed changing operation apparatus can comprise an operating lever shaft pivotally supported on a speed changing operation unit and an operating knob formed with a mounting bore configured to receive a top end of the operating lever shaft and adapted to be mounted on the top end of the operating lever shaft. The operating lever shaft can be configured to allow a user to conduct a speed changing operation of a transmission of vehicle by pivoting the operating lever shaft. The speed changing apparatus can further comprise an engagement member having a cylindrical configuration which has an inner circumferential configuration substantially the same as an outer circumferential configuration of the operating lever shaft. The engagement member can be adapted to be received and secured within the mounting bore of the operating knob and can comprise nails configured to be elastically deformed by the operating lever shaft and engaged therewith when the operating lever shaft is inserted through the engagement member.

In accordance with another embodiment, a lever assembly can comprise a lever shaft and an operating knob. The operating knob can comprise a mounting bore configured to receive a top end of the lever shaft and adapted to be mounted on the top end of the lever shaft. An engagement member can have a cylindrical configuration which has an inner circumferential configuration substantially the same as an outer circumferential configuration of the lever shaft. The engagement member can comprise nails configured to be elastically deformed by the lever shaft and engaged therewith when the lever shaft is inserted through the engagement member.

In accordance with yet another embodiment, a lever assembly can comprise a lever shaft and an operating knob comprising a mounting bore configured to receive a top end of the lever shaft and adapted to be mounted on the top end of the lever shaft, an engagement member having a cylindrical configuration which has an inner circumferential configuration substantially the same as an outer circumferential configuration of the operating lever shaft. The engagement member can comprise means for elastically engaging the lever shaft when the lever shaft is inserted through the engagement member.

### BRIEF DESCRIPTION OF THE DRAWINGS

Additional advantages and features of the present inventions will become apparent from the subsequent description and the appended claims, taken in conjunction with the accompanying drawings, wherein:

FIG. 1 is a perspective view of a speed changing operation apparatus for g to a preferable embodiment;

FIG. 2 is a perspective view of an operating lever shaft of the speed changing operation apparatus for vehicle of FIG. 1;

FIG. 3 (a) is a side elevation view of an operating knob of the speed changing operation apparatus for vehicle of FIG. 1, and FIG. 3 (b) is a front elevation view of the same;

FIG. 4 is a longitudinal section view showing an internal structure of the operating knob in the speed changing operation apparatus for vehicle of FIG. 1;

FIG. 5 (a) is a side elevation view of a core member of the operating knob of the speed changing operation apparatus for vehicle of FIG. 1, and FIG. 5 (b) is a front elevation view of the same;

FIG. 6 is a perspective view of an engagement member of the speed changing operation apparatus for vehicle of FIG. 1;

FIG. 7 is a side elevation view of the engagement member of the speed changing operation apparatus for vehicle of FIG. 1;

FIG. 8 is an explanatory view showing the assembly of the engagement member to the operating knob of the speed changing operation apparatus for vehicle of Fig. I;

FIG. 9 is a schematic view showing a process of engagement of the operating lever shaft relative to the engagement member (condition before engagement) ; and

FIG. 10 is a schematic view showing a next process of engagement of the operating lever shaft relative to the engagement member (condition after engagement).

### DESCRIPTION OF THE PREFERRED EMBODIMENTS

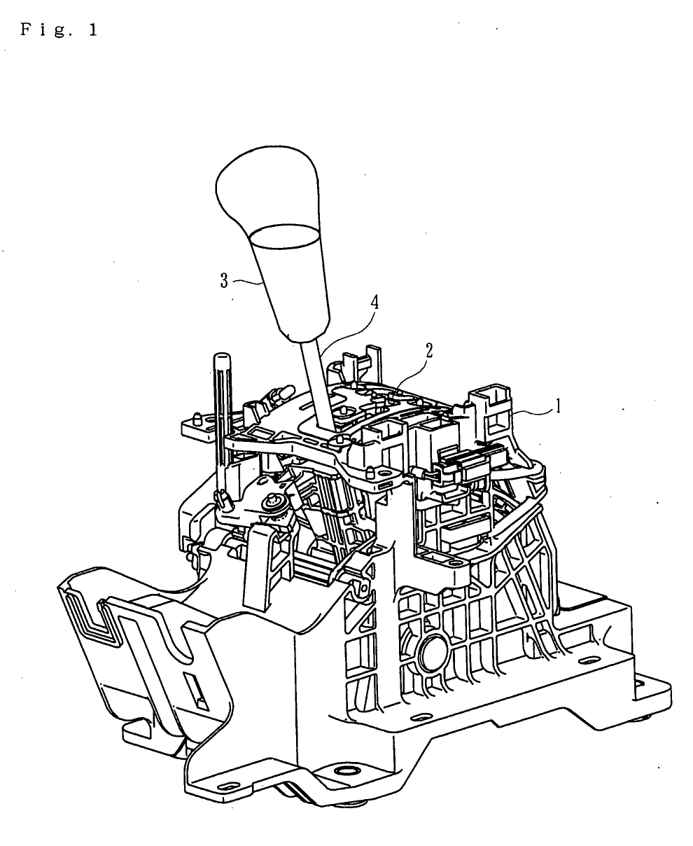

As shown in FIG. 1, a speed changing operation apparatus for a vehicle can generally comprise a speed changing operation unit 1 mounted on a body of vehicle, an operating lever shaft 4 pivotally movable along a gate groove 2 formed on the top of the speed changing operation unit 1, and an operating knob 3 mounted on the top end of the operating lever shaft 4. The lever and knob arrangements disclosed herein are described in the context of a speed changing apparatus for a vehicle. However, the lever and knob arrangement can have utility in other contexts, wherever a knob is used on the end of a lever.

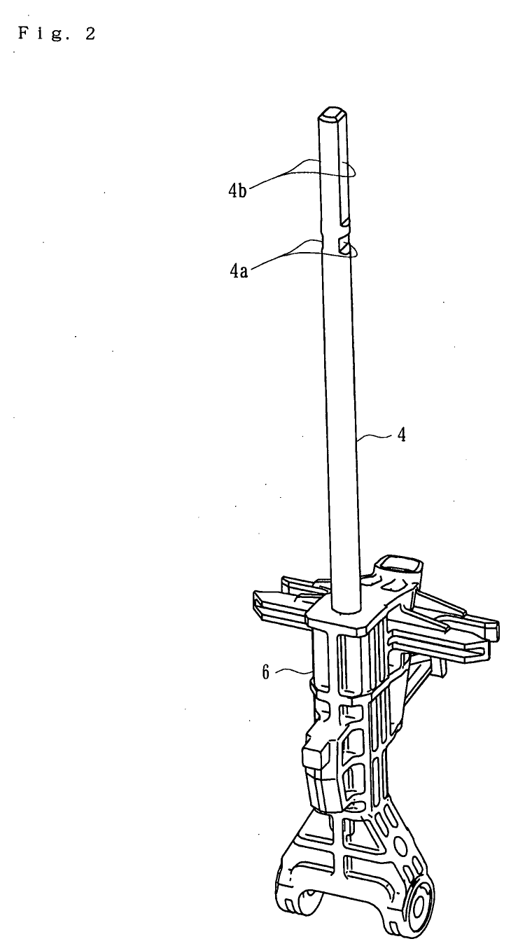

The speed changing operation unit 1 can be formed of plastic molded parts and supported so that its base end 6 (FIG. 2) formed on the base end of the operating lever shaft 4 can pivot fore and aft and/or right and left. Accordingly the operating lever shaft 4 can also pivot fore and aft as well as right and left along the gate groove 2. It is also possible to use the operating lever shaft 4 which can pivot only in the fore and aft direction.

As previously described, the operating lever shaft 4 can be pivoted around its end member 5 and is provided on its top end 6 with a operating knob 3 gripped by a driver of vehicle. As clearly shown in FIG. 2, the operating lever shaft 4 is formed with chamfered portions 4b over a predetermined region from its top end and is further formed with engagement recesses 4a below the chamfered portions 4b.

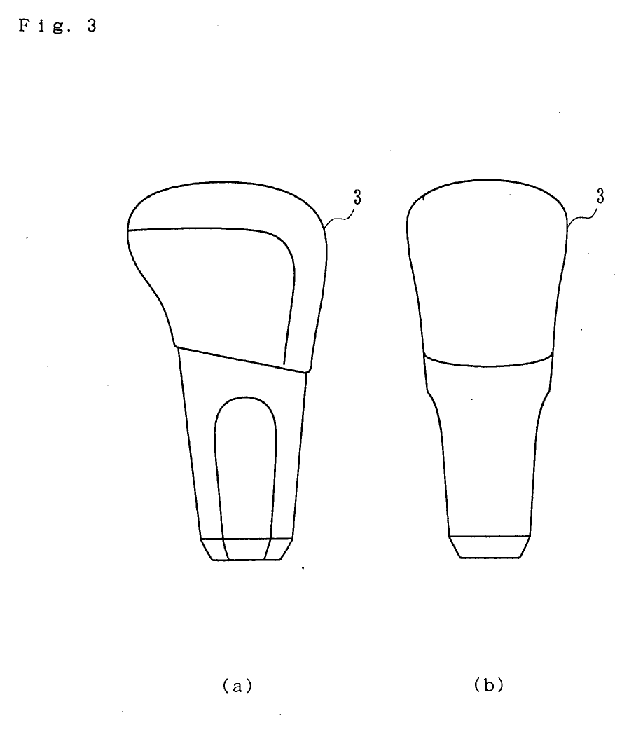

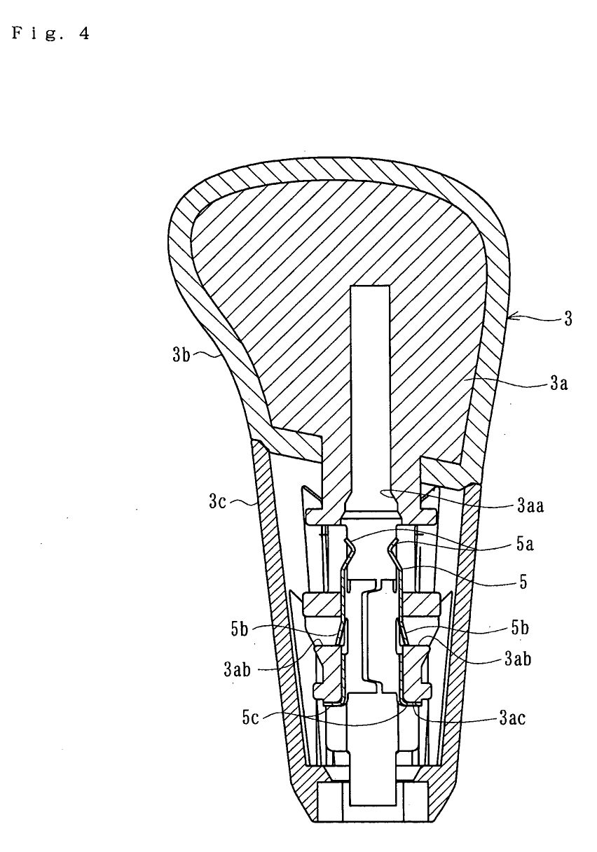

As clearly shown in FIGS. 3 and 4, the operating knob 3 is integrally formed by a core member 3a and skins 3b, 3c covering the core member 3a. In addition, the core member 3a is formed with a mounting bore 3aa for receiving the top end of the operating lever shaft 4. The mounting bore 3aa is formed so that it extends from the bottom of the core member 3a. The cross-sectional configuration of the mounting bore 3aa of the operating knob 3 has substantially same cross-sectional configuration as that of the chamfered portions 4b so that relative rotation between the operating lever shaft 4 and the operating knob 3 can be prevented once the knob 3 is mounted on the lever shaft 4.

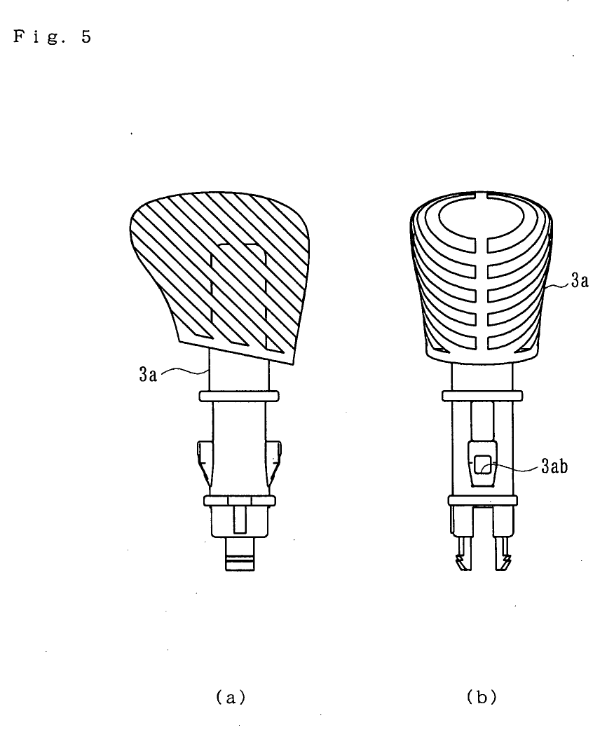

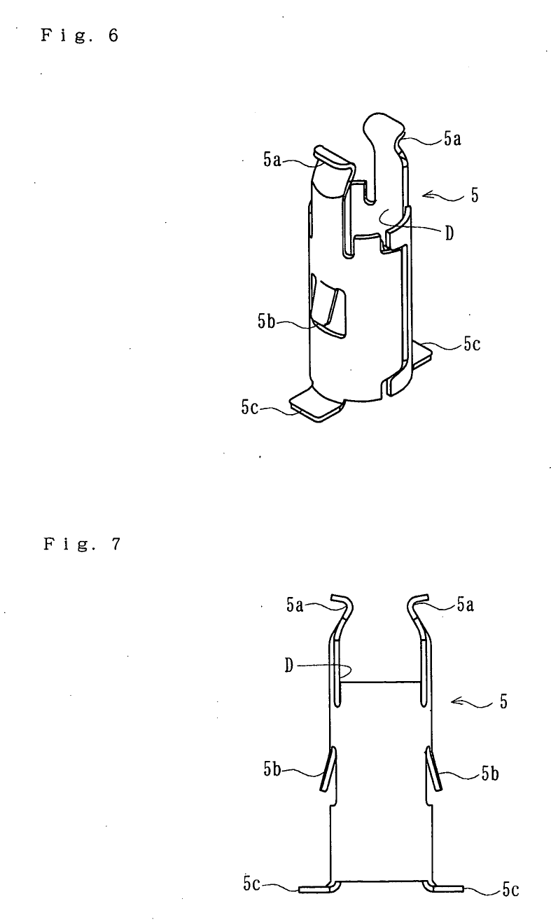

As shown in FIG. 5, the core member 3a of the operating knob 3 can be formed with an opening 3ab communicating inside and outside of the core member 3a. The opening 3ab is intended to be engaged by an engagement member 5 (FIGS. 6 and 7). The engagement member 5, as shown in FIGS. 6 and 7, can have a substantially cylindrical configuration having an inner diameter D which is substantially same as (somewhat larger than) an outer diameter of the operating lever shaft 4. That is, the cylindrical configuration of the engagement member 5 is substantially same as the outer diameter of the lever shaft 4 so that the lever shaft 4 can be inserted into the engagement member 5.

The engagement member 5 can be formed substantially at its axially central portion with a pair of engagement portions 5b extending laterally and which can be elastically deflectable radially. The engagement member 5 can be secured on the operating knob 3 within its mounting bore 3aa through engagement of the engagement portions 5b with edges of the openings 3ab of the core member 3a of the operating knob 3. That is, the radially deflectable engagement portions 5b can be deformed radially inwardly while the engagement member 5 is inserted into the mounting bore 3aa of the operating knob 3 from the bottom opening thereof. Thereafter, the engagement portions 5b can radially spring back into the openings 3ab and engage the edges thereof when the engagement portions 5b reach the openings 3ab.

In addition, the engagement member 5 can be formed at its bottom end with a pair of laterally extending securing portions 5c. The securing portions 5c can be adapted to be abutted against the end surface 3ac (FIG. 4) of the core member 3a when the engagement portions 5b are engaged with the edges of the openings 3ab. That is, the engagement member 5 cam be exactly positioned and secured within the mounting bore 3aa of the operating knob 3 (e.g., the core member 3a) by the engagement portions 5b and the securing portions 5c.

In this embodiment, the engagement member 5 is formed, at its top end, with a pair of nails 5a elastically deformable in the radial direction. Each of the nails 5a extends axially and can have a radially inwardly curved portion near its top end. The nails 5a can be bent radially outwardly when the lever shaft 4 is inserted into the engagement member 5. Thus, after the engagement member 5 is secured within the mounting bore 3aa, insertion of the operating lever shaft 4 into the engagement member 5 enables the lever shaft 4 to be secured within the engagement member 5 (i.e. the mounting bore 3aa of the knob 3) due to snap engagement of the nails 5a of the engagement member 5 into the engagement recess 4a of lever shaft 4.

Then the method for mounting the operating knob 3 on the operating lever shaft 4 is described more in detail below.

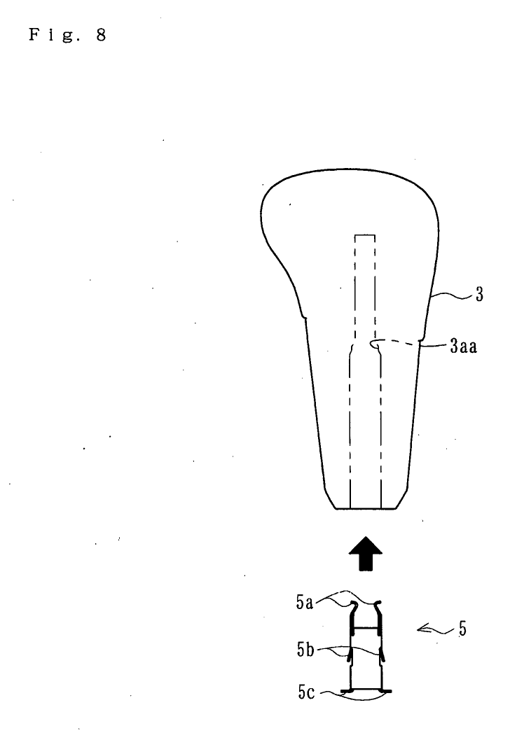

First of all, as shown in FIG. 8, the engagement member 5 can be inserted into the mounting bore 3aa of the operating knob 3 and secured therein. In this condition, the engagement member 5 is precisely positioned and secured in the mounting bore 3aa with the engagement portions 5b engaging the edges of the openings 3ab as well as the securing portions 5b abutting against the bottom surface 3ac of the core member 3a.

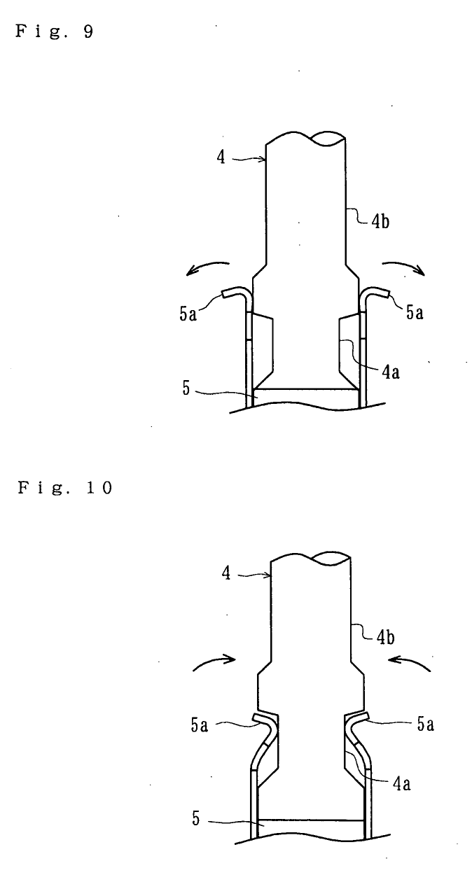

Then the lever shaft 4 can be inserted into the mounting bore 3aa of the knob 3. After the top end of the lever shaft 4 has passed through the engagement member 5, the nails 5a are elastically expanded radially outward by the lever shaft 4 as shown in FIG. 9 and allow the level shaft 4 to further advance. Then the nails 5a spring back and snap into the engagement recesses 4a as shown in FIG. 10.

Simultaneously with this snapping action of the nails 5a, the engagement portions 5b of the engagement member 5 are also elastically expanded radially outwardly and engage the edges of the openings 3ab. Additionally, the securing portions 5c of the abutment member 5 abut against the bottom face of the core member 3a of the knob 3. Accordingly the operation knob 3 can be secured on the lever shaft 4 and can be prevented from being slipped off from the lever shaft 4. This simple and easy mounting method enables to reduce the number of assembling steps as comparing with the mounting method of the prior art using screws. In addition since substantially large outer circumferential surface of the lever shaft 4 can be covered by the inner circumferential surface D of the engagement member 5, it is possible to stably mount the knob 3 on the without generation of rattle.

In addition, since the engagement member 5 has a cylindrical configuration enabling the operating lever shaft 4 to be passed therethrough, it is possible to elastically support the operating knob 3 at any position relative to the lever shaft 4 by changing the securing position of the engagement member 5 within the knob 3. Furthermore, since the nails 5a of the engagement member 5 engage the engagement recesses 4a formed on the outer circumferential surface of the lever shaft 4, the operating knob 3 can be elastically supported on the lever shaft 4 more firmly and stably. In addition, since the nails 5a are arranged on the lever shaft 4 in one pair fashion oppositely in the diametrical direction thereof, the knob 3 can be assembled to the lever shaft 4 more stably.

The present inventions are not limited to the illustrated and described embodiments and thus many modifications may be incorporated. For example, it may be possible to elastically support the operating knob 3 on the operating lever shaft 4 at a plurality of points by providing three or more nails 5a. In addition although it is illustrated and described that the cross-sectional configuration of the lever shaft 4 is round, other any cross-sectional configuration (e.g. rectangular or ellipse etc.) may be adopted. In these cases, the cross-sectional configuration of the engagement member 5 can be substantially same as that of the lever shaft 4.

In addition, the engagement member 5 can be secured in the mounting bore 3aa of the core member 3a of the knob 3 using any other form. Although the illustrated embodiments are applied to an automatic speed changing apparatus in the so-called automatic transmission vehicle, it can be applied to the so-called manual transmission vehicle.

If the speed changing operation apparatus for vehicle is a type comprising an engagement member having a cylindrical configuration of substantially same inner circumferential configuration as an outer circumferential configuration of the operating lever shaft, the engagement member being adapted to be received and secured within the mounting bore of the operating knob and having nails being able to be elastically deformed by the operating lever shaft and engaged therewith when the operating lever shaft is inserted through the engagement member, it is possible to apply the speed changing operation apparatus for vehicle of the present invention to that having a different outline configuration or additional functions.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

What is claimed is:

1. A speed changing operation apparatus for a vehicle comprising an operating lever shaft pivotally supported on a speed changing operation unit and an operating knob formed with a mounting bore configured to receive a top end of the operating lever shaft and adapted to be mounted on the top end of the operating lever shaft, the operating lever shaft being configured to allow a user to conduct a speed changing operation of a transmission of vehicle by pivoting the operating lever shaft, the speed changing apparatus further comprising an engagement member having a cylindrical configuration which has an inner circumferential configuration substantially the same as an outer circumferential configuration of the operating lever shaft, the engagement member being adapted to be received and secured within the mounting bore of the operating knob and comprising nails configured to be elastically deformed by the operating lever shaft and engaged therewith when the operating lever shaft is inserted through the engagement member.

2. A speed changing operation apparatus for vehicle of claim 1, wherein the operating lever shaft is formed with engagement recesses on its outer circumferential surface, the engagement recesses being configured to engage with the nails of the engagement member.

3. A speed changing operation apparatus for vehicle of claim 1, wherein at least one pair of the nails is formed on the engagement member and arranged such that the nails are opposite each other across a diameter of the operating lever shaft.

4. A speed changing operation apparatus for vehicle of claim 1, wherein the operating knob is integrally formed by a core member and skins covering the core member, the mounting bore being formed on the core member so that it extends from the bottom of the core member.

5. A speed changing operation apparatus for vehicle of claim 4, wherein the core member of the operating knob is formed with openings, the engagement member being configured to be secured on the operating knob through engagement of the engagement member with the openings.

6. A speed changing operation apparatus for vehicle of claim 5, wherein the engagement member comprises a pair of laterally extending engagement portions formed substantially at its axially central portion, the engagement portions being elastically deflectable radially, the engagement member being configured to be secured on the operating knob within its mounting bore through engagement of the engagement portions with edges of the openings of the core member of the operating knob.

7. A speed changing operation apparatus for vehicle of claim 6, wherein the engagement member includes a pair of laterally extending securing portions disposed at its bottom end, the securing portions being adapted to be abutted against the end surface of the core member when the engagement portions are engaged with the edges of the openings.

8. A speed changing operation apparatus for vehicle of claim 1, wherein the operating lever shaft is formed with chamfered portions over a predetermined region from its top end, the cross-sectional configuration of the operating lever shaft at which the chamfered portions are formed having substantially the same cross-sectional configuration as the mounting bore of the operating knob so that relative rotation between the operating lever shaft and the operating knob is prevented when the knob is mounted on the lever shaft.

9. A speed changing operation apparatus for vehicle of claim 1, wherein the operating lever shaft is mounted on the speed changing operation unit so that it can pivot fore and aft as well as right and left directions along gate grooves formed on the speed changing operation unit.

10. A lever assembly comprising a lever shaft, an operating knob comprising a mounting bore configured to receive a top end of the lever shaft and adapted to be mounted on the top end of the lever shaft, an engagement member having a cylindrical configuration which has an inner circumferential configuration substantially the same as an outer circumferential configuration of the lever shaft, the engagement member comprising nails configured to be elastically deformed by the lever shaft and engaged therewith when the lever shaft is inserted through the engagement member.

11. A lever assembly of claim 10, wherein the lever shaft is formed with engagement recesses on its outer circumferential surface, the engagement recesses being configured to engage with the nails of the engagement member.

12. A lever assembly of claim 10, wherein at least one pair of the nails is formed on the engagement member and arranged such that the nails are opposite each other across a diameter of the lever shaft.

13. A lever assembly of claim 10, wherein the operating knob is integrally formed by a core member and skins covering the core member, the mounting bore being formed on the core member so that it extends from the bottom of the core member.

14. A lever assembly of claim 13, wherein the core member of the operating knob is formed with openings, the engagement member being configured to be secured on the operating knob through engagement of the engagement member with the openings.

15. A lever assembly of claim 14, wherein the engagement member comprises a pair of laterally extending engagement portions formed substantially at its axially central portion, the engagement portions being elastically deflectable radially, the engagement member being configured to be secured on the operating knob within its mounting bore through engagement of the engagement portions with edges of the openings of the core member of the operating knob.

16. A lever assembly of claim 15, wherein the engagement member includes a pair of laterally extending securing portions disposed at its bottom end, the securing portions being adapted to be abutted against the end surface of the core member when the engagement portions are engaged with the edges of the openings.

17. A lever assembly of claim 10, wherein the lever shaft is formed with chamfered portions over a predetermined region from its top end, the cross-sectional configuration of the lever shaft at which the chamfered portions are formed having substantially the same cross-sectional configuration as the mounting bore of the operating knob so that relative rotation between the operating lever shaft and the operating knob is prevented when the knob is mounted on the lever shaft.

18. A lever assembly of claim 10 in combination with a speed changing operation unit of a vehicle, wherein the lever shaft is mounted on the speed changing operation unit so that it can pivot fore and aft as well as right and left directions along gate grooves formed on the speed changing operation unit.

19. A lever assembly comprising a lever shaft, an operating knob comprising a mounting bore configured to receive a top end of the lever shaft and adapted to be mounted on the top end of the lever shaft, an engagement member having a cylindrical configuration which has an inner circumferential configuration substantially the same as an outer circumferential configuration of the operating lever shaft, the engagement member comprising means for elastically engaging the lever shaft when the lever shaft is inserted through the engagement member.
